(19) United States
(12) Patent Application Publication
(10) Pub. No.: US 2012/0256987 A1
(43) Pub. Date: Oct. 11, 2012

(54) LIQUID EJECTING APPARATUS AND METHOD OF CONTROLLING LIQUID EJECTING APPARATUS

(75) Inventors: Masaru KOBASHI, Matsumoto (JP); Yoichi YAMADA, Shiojiri (JP); Toshiya OKADA, Chino (JP)

(73) Assignee: SEIKO EPSON CORPORATION, Tokyo (JP)

(21) Appl. No.: 13/438,407

(22) Filed: Apr. 3, 2012

(30) Foreign Application Priority Data
Apr. 5, 2011 (JP) 2011-083392

(51) Int. Cl. B41J 2/16

(52) U.S. Cl. 347/47

(57) ABSTRACT

A liquid ejecting apparatus includes: a liquid ejecting head which ejects toward a landing target liquid from a nozzle opened in an electrically grounded nozzle formation face; a support section which is disposed spaced apart from the nozzle formation face of the liquid ejecting head when performing an ejection operation and supports the landing target; and a voltage application section which applies voltage to the support section, wherein the voltage which is applied to the support section is set to be equal to or higher than −305 V and lower than 0 V.

### BACKGROUND

1. Technical Field

The present invention relates to a liquid ejecting apparatus such as an ink jet type recording apparatus, and in particular, to a liquid ejecting apparatus which ejects liquid in a pressure chamber from a nozzle by driving of a pressure generation section, and a method of controlling the liquid ejecting apparatus.

2. Related Art

A liquid ejecting apparatus is an apparatus which is provided with a liquid ejecting head and which ejects various liquids from the liquid ejecting head. As such liquid ejecting apparatuses, for example, there are image recording apparatuses such as an ink jet type printer or an ink jet type plotter. However, in recent years, liquid ejecting apparatuses have also been applied to various manufacturing apparatuses taking advantage of their feature of being capable of making a very small amount of liquid precisely land at a given position. They have been applied to, for example, a display manufacturing apparatus which manufactures a color filter of a liquid crystal display or the like, an electrode forming apparatus which forms an electrode of an organic EL (Electro Luminescence) display, an FED (Field Emission Display), or the like, and a chip manufacturing apparatus which manufactures a biochip (a biochemical element). Then, in a recording head for the image recording apparatus, liquid ink is ejected, and in a color material ejecting head for the display manufacturing apparatus, a solution of each color material of R (red), G (green), and B (blue) is ejected. Further, in an electrode material ejecting head for the electrode forming apparatus, a liquid electrode material is ejected, and in a biological organic matter ejecting head for the chip manufacturing apparatus, a solution of biological organic matter is ejected.

In a recording head which is used in the printer or the like mentioned above, in recent years, in order to meet the needs of improvement in images and the like, there has been a tendency to reduce the amount of ink which is ejected from the nozzle. In order to make such a liquid droplet of a miniscule amount reliably land on a recording medium, the initial speed of the liquid droplet is set relatively high. In this way, the liquid droplet ejected from the nozzle elongates during flight, thereby being divided into a leading main droplet (a main droplet) and a following satellite droplet (a sub-droplet). Some or all of the satellite droplets rapidly decrease in speed due to the viscous resistance of air, thereby being sometimes turned into mist without reaching the recording medium. Accordingly, there is a problem in that the satellite droplets (ink mist) turned into mist contaminate the inside of the apparatus, thereby causing malfunction by attachment to an easily charged member such as a recording head or an electric circuit.

In order to prevent such a defect, an attempt has been made to actively attract liquid droplets, which are ejected from the nozzle, to a support member (or a platen or a base material) which supports a recording medium at the time of recording, thereby making the liquid droplets land on the recording medium, by electrically charging the liquid droplets and also forming an electric field between a nozzle formation face of the recording head and the support member (refer to JP-A-10-278252 or JP-A-2004-202867, for example).

Incidentally, in the printers like those described above, there is a case where design of the distance between the nozzle formation face and the support member is changed depending on the application, the thickness of the recording medium, or the like. In such a case, the electric field intensity between the nozzle formation face and the support member varies, so that there is a concern that it may not be possible to suitably collect mist. For this reason, in order to make the electric field intensity between the nozzle formation face which is usually grounded and the support member uniform before and after a change in design, it is necessary to change the voltage of the support member. For example, in a case where the distance between the nozzle formation face and the support member is widened, accordingly, the voltage of the support member is increased such that the electric field intensity between the nozzle formation face and the support member conforms to that before the change in design. However, there is a case where a problem arises in that mist attaches to the nozzle formation face or a component of the printer in spite of the fact that the electric field is formed between the nozzle formation face and the support member. This phenomenon has not been elucidated in detail and design guidelines for the voltage which is to be applied to the support member have not been obtained.

### SUMMARY

An advantage of some aspects of the invention is that it provides a liquid ejecting apparatus in which attachment of liquid which is ejected from a nozzle to the inside of the apparatus can be prevented by defining the voltage which is applied to a support member, and a method of controlling the liquid ejecting apparatus.

According to an aspect of the invention, there is provided a liquid ejecting apparatus including: a liquid ejecting head which ejects liquid toward a landing target from a nozzle opened in an electrically grounded nozzle formation face; a support section which is disposed spaced apart from the nozzle formation face of the liquid ejecting head when performing an ejection operation and supports the landing target; and a voltage application section which applies voltage to the support section, wherein the voltage which is applied to the support section is set to be equal to or higher than −305 V and lower than 0 V.

Further, according to another aspect of the invention, there is provided a method of controlling a liquid ejecting apparatus which includes a liquid ejecting head which ejects liquid toward a landing target from a nozzle opened in an electrically grounded nozzle formation face; a support section which is disposed spaced apart from the nozzle formation face of the liquid ejecting head when performing an ejection operation and supports the landing target; and a voltage application section which applies voltage to the support section, the method including: setting the voltage which is applied to the support section to be equal to or higher than −305 V and lower than 0 V.

According to the above aspects of the invention, by setting the voltage which is applied to the support section to be equal to or higher than −305 V and lower than 0 V, it is possible to suppress electrical charging of mist which is generated along with liquid droplets which are ejected from the nozzle. Accordingly, the attachment of mist to a component (for example, a driving motor, a driving belt, a linear scale, or the like) in the apparatus can be reduced, so that breakdowns due to the attachment of mist are prevented, whereby it is possible to improve the durability and reliability of the liquid ejecting apparatus.

### BRIEF DESCRIPTION OF THE DRAWINGS

The invention will be described with reference to the accompanying drawings, wherein like numbers reference like elements.

FIG. 1 is a perspective view describing the configuration of a printer.

FIG. 2 is a cross-sectional view of a main section of a recording head.

FIG. 3 is a cross-sectional view describing the configuration of a piezoelectric vibrator.

FIG. 4 is a block diagram describing the electrical configuration of the printer.

FIG. 5 is a waveform diagram describing the configurations of an ejection driving pulse and a micro-vibration driving pulse.

FIG. 6 is a graph showing the relationship between the platen applied voltage and the amount of mist attached to a nozzle formation face.

FIG. 7 is a schematic diagram describing a situation where ink ejected from a nozzle is electrically charged.

FIG. 8 is a schematic diagram describing a situation where mist is electrically charged.

### DESCRIPTION OF EXEMPLARY EMBODIMENTS

Hereinafter, a mode for carrying out the invention will be described with reference to the accompanying drawings. In addition, although in the embodiments which are described below, various limitations are given as preferred specific examples of the invention, the scope of the invention is not limited to these aspects unless the description of intent to limit the invention is particularly provided in the following description. Also, in the following description, an ink jet type recording apparatus (hereinafter, referred to as a printer) is described as an example of a liquid ejecting apparatus according to the invention.

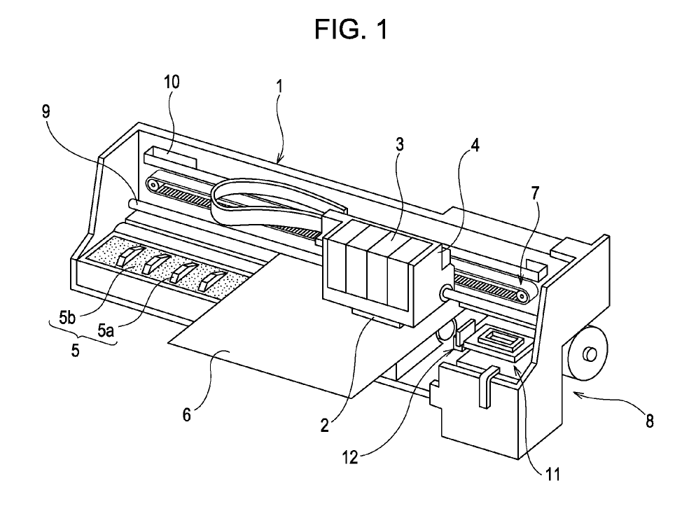

FIG. 1 is a perspective view showing the configuration of a printer 1. The printer 1 includes a carriage 4, on which a recording head 2 that is one type of liquid ejecting head is mounted and an ink cartridge 3 that is one type of liquid supply source is also detachably mounted, a platen 5 disposed, spaced apart from the lower surface (a nozzle formation face) of the recording head 2, on the lower side of the recording head 2 at the time of a recording operation (an ejection operation), a carriage movement mechanism 7 which reciprocates the carriage 4 in the paper width direction of recording paper 6 (one type of either a recording medium or a landing target), that is, a main scanning direction, and a transport mechanism 8 which transports the recording paper 6 in a sub-scanning direction perpendicular to the main scanning direction.

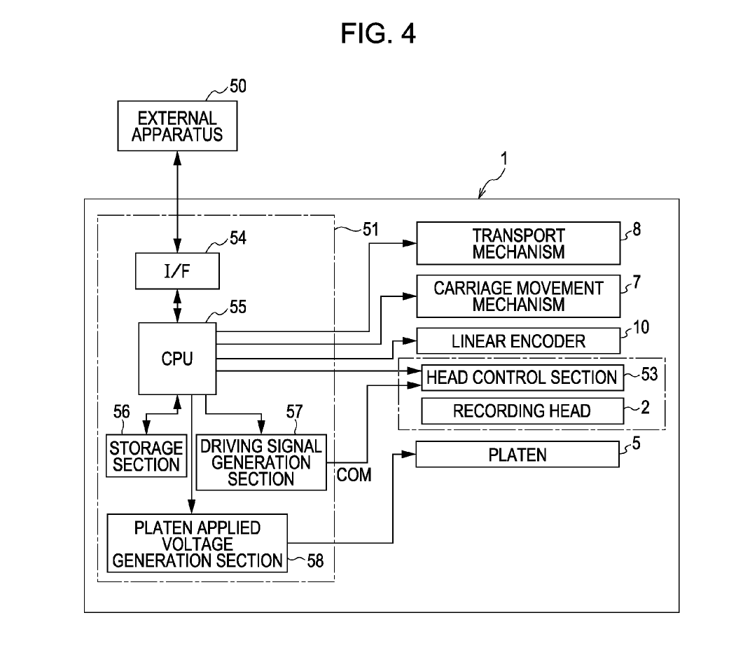

The carriage 4 is mounted in a state where it is pivotally supported on a guide rod 9 provided to extend in the main scanning direction, and is configured so as to move in the main scanning direction along the guide rod 9 by an operation of the carriage movement mechanism 7. A position in the main scanning direction of the carriage 4 is detected by a linear encoder 10 and the detection signal, that is, an encoder pulse (one type of position information) is transmitted to a printer controller 51 (refer to FIG. 4). The linear encoder 10 is one type of position information output section and outputs an encoder pulse EP according to a scanning position of the recording head 2, as position information in the main scanning direction.

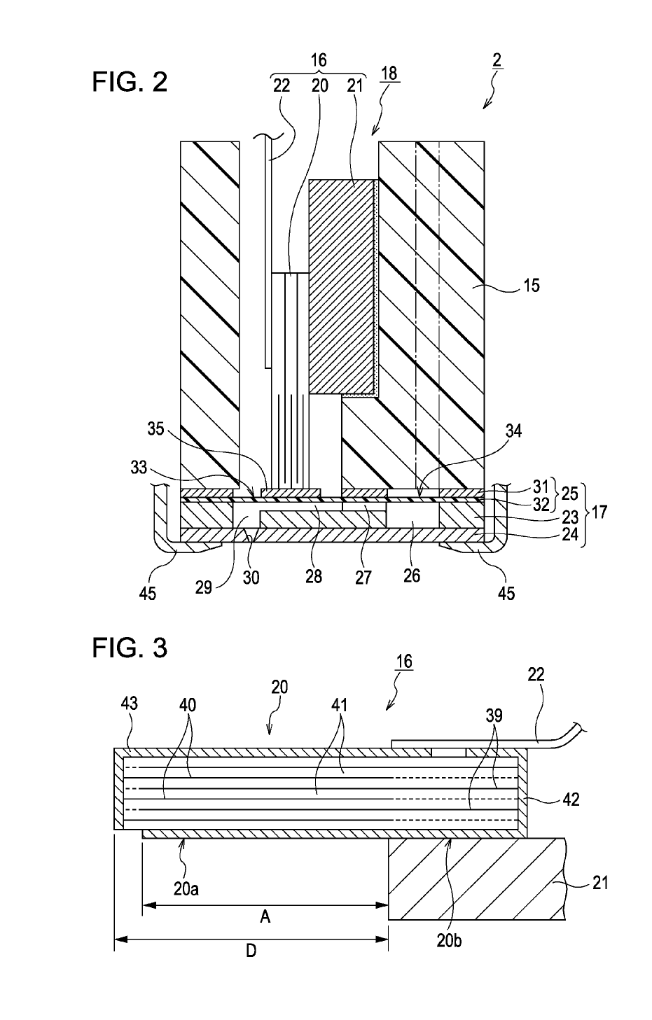

At an end portion area outside the recording area within the movement range of the carriage 4, a home position that becomes a base point for scanning of the carriage is set. At the home position in this embodiment, a capping member 11 which seals the nozzle formation face (a nozzle plate 24; refer to FIG. 2) of the recording head 2 and a wiper member 12 for sweeping the nozzle formation face are disposed. Then, the printer 1 is configured such that so-called bi-directional recording is possible, which records a character, an image, or the like on the recording paper 6 in both directions at the time of forward movement in which the carriage 4 moves from the home position toward an end portion on the opposite side and the time of return movement in which the carriage 4 returns from the end portion on the opposite side to the home position side.

The platen 5 is a plate-like member which is long in the main scanning direction, and on the surface thereof, a plurality of support projections 5a is provided in a protruding state at given intervals along the longitudinal direction. Each support projection 5a protrudes further to the upper side (the recording head 2 side at the time of the recording operation) than the surface of the platen. The upper surface of each support projection 5a becomes a contact surface which supports the recording paper 6, and partially supports the rear surface (the surface on the opposite side to a recording surface on which ink lands) of the recording paper 6. Further, at a portion deviated from each support projection 5a in the surface of the platen 5, an ink absorber 5b is disposed. The ink absorber 5b is formed by a porous member made of, for example, felt, sponge, or the like and having liquid absorptivity. At least a portion of the platen 5 in this embodiment is formed by a conductive material. For example, by including an electrically-conductive material such as carbon in a material of the main body of the platen 5, the platen 5 can be made to be conductive. Otherwise, it is also acceptable to make the ink absorber 5b conductive by including an electrically-conductive material in a material of the ink absorber 5b. Then, a configuration is made such that voltage from a platen applied voltage generation section 58, which will be described later, is applied to the platen 5 (the ink absorber 5b in a case where the ink absorber 5b is made to be conductive). The details of this point will be described later.

FIG. 2 is a cross-sectional view of a main section describing the configuration of the recording head 2. The recording head 2 includes a case 15, a vibrator unit 16 which is accommodated in the case 15, a flow path unit 17 which is joined to the bottom face (the leading end face) of the case 15, a cover member 45, and the like. The case 15 is made of, for example, epoxy-based resin, and in the inside thereof, an accommodating cavity portion 18 for accommodating the vibrator unit 16 is formed. The vibrator unit 16 includes a piezoelectric vibrator 20 which functions as one type of pressure generation section, a fixed plate 21 to which the piezoelectric vibrator 20 is joined, and a flexible cable 22 which supplies a driving signal to the piezoelectric vibrator 20.

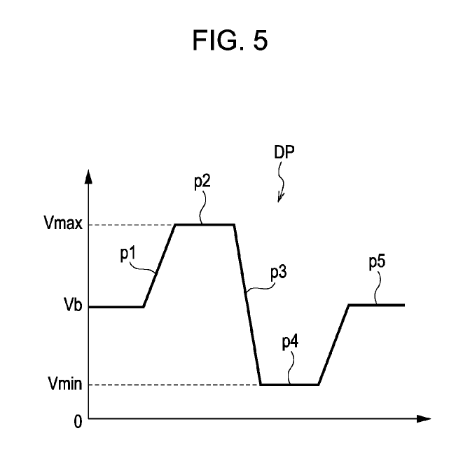

FIG. 3 is a cross-sectional view in a longitudinal direction of an element, which describes the configuration of the vibrator unit 16. As shown in the drawing, the piezoelectric vibrator 20 is a lamination type piezoelectric vibrator formed by alternately laminating a common internal electrode 39 and an individual internal electrode 40 with a piezoelectric body 41 interposed therebetween. Here, the common internal electrode 39 is an electrode common to all the piezoelectric vibrators 20 and is set to have a ground potential. Further, the individual internal electrode 40 is an electrode in which a potential varies according to an ejection driving pulse DP (refer to FIG. 5) of a driving signal which is applied thereto. Then, in this embodiment, a portion from the leading end of the vibrator to about half or about two-thirds in a longitudinal direction (a direction perpendicular to a lamination direction) of the vibrator in the piezoelectric vibrator 20 becomes a free end portion 20a. Further, the remaining portion in the piezoelectric vibrator 20, that is, the portion from a base end of the free end portion 20a to a base end of the vibrator becomes a base end portion 20b.

At the free end portion 20a, an active region (an overlap portion) A in which the common internal electrode 39 and the individual internal electrode 40 overlap each other is formed. If a difference in potential is given to these internal electrodes 39 and 40, the piezoelectric body 41 in the active region A operates and is deformed, so that the free end portion 20a is displaced in the longitudinal direction of the vibrator to expand or contract. Then, a base end of the common internal electrode 39 is electrically connected to a common external electrode 42 at a base end face portion of the piezoelectric vibrator 20. On the other hand, the leading end of the individual internal electrode 40 is electrically connected to an individual external electrode 43 at the leading end face portion of the piezoelectric vibrator 20. In addition, the leading end of the common internal electrode 39 is located slightly ahead of (further on the base end face side) the leading end face portion of the piezoelectric vibrator 20 and a base end of the individual internal electrode 40 is located at the boundary between the free end portion 20a and the base end portion 20b.

The individual external electrode 43 is an electrode formed to be continuous on the leading end face portion of the piezoelectric vibrator 20 and a wiring connection face (a face on the upper side in FIG. 3) that is one side face in the lamination direction of the piezoelectric vibrator 20 and electrically connects a wiring pattern of the flexible cable 22 as a wiring member and each individual internal electrode 40 to each other. Then, the portion on the wiring connection face side of the individual external electrode 43 is continuously formed from above the base end portion 20b toward the leading end side. The common external electrode 42 is an electrode formed to be continuous on the base end face portion of the piezoelectric vibrator 20, the wiring connection face, and a fixed plate mounting face (a face on the lower side in FIG. 3) that is the other side face in the lamination direction of the piezoelectric vibrator 20 and electrically connects the wiring pattern of the flexible cable 22 and each common internal electrode 39 to each other. Then, the portion on the wiring connection face side of the common external electrode 42 is continuously formed from just before an end portion of the individual external electrode 43 toward the base end face side, and the portion on the fixed plate mounting face side is continuously formed from a position just before the leading end face portion of the vibrator toward the base end side.

The base end portion 20b is a non-operation portion which does not expand and contract even at the time of operation of the piezoelectric body 41 in the active region A. On the wiring connection face side of the base end portion 20b, the flexible cable 22 is disposed, and the individual external electrode 43 and the common external electrode 42 are electrically connected to the flexible cable 22 above the base end portion 20b. Then, a driving signal is applied to each individual external electrode 43 through the flexible cable 22.

The flow path unit 17 is configured by joining the nozzle plate 24 to the face on one side of a flow path formation substrate 23 and joining a vibration plate 25 to the face on the other side of the flow path formation substrate 23. In the flow path unit 17, a reservoir 26 (a common liquid chamber), an ink supply port 27, a pressure chamber 28, a nozzle communication port 29, and a nozzle 30 are provided. Then, a successive ink flow path from the ink supply port 27 through the pressure chamber 28 and the nozzle communication port 29 to the nozzle 30 is formed corresponding to each nozzle 30.

The nozzle plate 24 is a thin plate made of metal such as stainless steel, in which a plurality of nozzles 30 is perforated in a row at a pitch (for example, 180 dpi) corresponding to dot formation density. In the nozzle plate 24, the nozzles 30 are arranged in a row, so that a nozzle row (a nozzle group) is provided in a plurality, and one nozzle row is composed of 180 nozzles 30, for example. The face on the side where ink is ejected from the nozzles 30 of the nozzle plate 24 is equivalent to the nozzle formation face in the invention.

The vibration plate 25 has an overlapping structure in which an elastic body film 32 is laminated on the surface of a support plate 31. In this embodiment, the vibration plate 25 is made by using a composite plate material in which a stainless steel plate that is one type of metal plate is used as the support plate 31 and a resin film as the elastic body film 32 is laminated on the surface of the support plate 31. In the vibration plate 25, a diaphragm portion 33 which changes the volume of the pressure chamber 28 is provided. Further, in the vibration plate 25, a compliance portion 34 which seals a portion of the reservoir 26 is provided.

The diaphragm portion 33 is made by partially removing the support plate 31 by etching or the like. That is, the diaphragm portion 33 is composed of an island portion 35 to which the leaning end face of the free end portion 20a of the piezoelectric vibrator 20 is joined and a thin-walled elastic portion which surrounds the island portion 35. The compliance portion 34 is made by removing the support plate 31 in an area facing an opening face of the reservoir 26 by etching or the like, similarly to the diaphragm portion 33, and functions as a damper which absorbs a fluctuation in pressure of liquid retained in the reservoir 26.

Then, since the leading end face of the piezoelectric vibrator 20 is joined to the island portion 35, the volume of the pressure chamber 28 can be fluctuated by expansion and contraction of the free end portion 20a of the piezoelectric vibrator 20. A fluctuation in pressure occurs in ink in the pressure chamber 28 in accordance with the fluctuation in volume. Then, the recording head 2 ejects ink from the nozzle 30 with use of the fluctuation in pressure.

The cover member 45 is a member which protects the side face of the flow path unit 17 or the side face of the case 15, and is made of a plate material having conductivity, such as stainless steel. A portion of the cover member 45 in this embodiment comes into contact with a peripheral portion of the nozzle formation face in a state where the nozzles 30 of the nozzle plate 24 are exposed, and is electrically connected to the nozzle plate 24. The cover member 45 is grounded and comes into contact with the nozzle plate 24 in an electrical conduction state, whereby damage to a driving IC or the like or electrical charging of the nozzle plate 24 due to static electricity which is generated from, for example, the recording paper 6 or the like and then transmitted thereto through the nozzle plate 24 is prevented.

Next, the electrical configuration of the printer 1 will be described.

FIG. 4 is a block diagram describing the electrical configuration of the printer 1. An external apparatus 50 is an electronic apparatus which deals with images, such as a computer or a digital camera, for example. The external apparatus 50 is connected to the printer controller 51 of the printer 1 so as to be able to communicate therewith and transmits printing data corresponding to an image or the like to the printer 1 in order to print the image or a text on a recording medium such as recording paper in the printer 1.

The printer 1 in this embodiment includes the transport mechanism 8, the carriage movement mechanism 7, the linear encoder 10, the recording head 2, the platen 5, and the printer controller 51.

The printer controller 51 is a control unit for performing control of each section of the printer and includes an interface (I/F) section 54, a CPU 55, a storage section 56, a driving signal generation section 57, and the platen applied voltage generation section 58. The interface section 54 performs transmission and reception of printer state data, such as sending printing data or printing instructions from the external apparatus 50 to the printer 1 or sending the state information of the printer 1 to the external apparatus 50. The CPU 55 is an arithmetic processing device for performing control of the whole of the printer. The storage section 56 is an element which stores a program of the CPU 55 or data which is used in a variety of controls, and includes a ROM, a RAM, and an NVRAM (a non-volatile memory element). The CPU 55 controls each unit in accordance with a program which is stored in the storage section 56.

The CPU 55 functions as a timing pulse generation section which generates a timing pulse PTS from the encoder pulse EP which is output from the linear encoder 10. Then, the CPU 55 controls transmission of the printing data, generation of a driving signal COM by the driving signal generation section 57, or the like in synchronization with the timing pulse PTS. Further, the CPU 55 generates a timing signal such as a latch signal LAT on the basis of the timing pulse PTS and outputs it to a head control section 53 of the recording head 2. The head control section 53 performs control or the like of application of the ejection driving pulse DP (refer to FIG. 5) of the driving signal COM to the piezoelectric vibrator 20 of the recording head 2 on the basis of a head control signal (the printing data and the timing signal) from the printer controller 51.

The platen applied voltage generation section 58 (equivalent to a voltage application section in this invention) functions as an electric power supply which generates voltage that is applied to the platen 5. Then, a configuration is adopted such that the platen 5 is electrically charged to have negative polarity by applying a certain voltage to the platen 5. In addition, the details of this point will be described later.

The driving signal generation section 57 generates an analog voltage signal on the basis of wavelength data related to the waveform of the driving signal. Further, the driving signal generation section 57 amplifies the voltage signal, thereby generating the driving signal COM. The driving signal COM is a signal which is applied to the piezoelectric vibrator 20 that is a pressure generation section of the recording head 2 at the time of a printing process (a recording process or an ejection process) on the recording medium, and is a successive signal which includes at least one or more ejection driving pulses DP shown in FIG. 5, for example, within a unit period that is a repetition period. Here, the ejection driving pulse DP is for making the piezoelectric vibrator 20 carry out a given operation in order to eject ink in droplet form from the nozzle 30 of the recording head 2.

FIG. 5 is a waveform diagram showing one example of the configuration of the ejection driving pulse DP which is included in the driving signal COM. In addition, in FIG. 5, the vertical axis denotes potential and the horizontal axis denotes time. Further, the ejection driving pulse DP includes an expansion element p1 in which a potential changes to the positive side from a reference potential (an intermediate potential) Vb to a maximum potential (a maximum voltage) Vmax, thereby expanding the pressure chamber 28, an expansion maintaining element p2 which maintains the maximum potential Vmax for a given length of time, a contraction element p3 in which a potential changes to the negative side from the maximum potential Vmax to a minimum potential (a minimum voltage) Vmin, thereby rapidly contracting the pressure chamber 28, a contraction maintaining (vibration suppression holding) element p4 which maintains the minimum potential Vmin for a given length of time, and a return element p5 in which a potential returns from the minimum potential Vmin to the reference potential Vb.

If the ejection driving pulse DP is applied to the piezoelectric vibrator 20, an operation is performed as follows. First, the piezoelectric vibrator 20 contracts due to the expansion element p1, whereby, the pressure chamber 28 expands from the reference volume corresponding to the reference potential Vb to the maximum volume corresponding to the maximum potential Vmax. In this way, a meniscus which is exposed in the nozzle 30 is drawn to the pressure chamber side. An expansion state of the pressure chamber 28 is constantly maintained during an application period of the expansion maintaining element p2. If the contraction element p3 is applied to the piezoelectric vibrator 20 subsequently to the expansion maintaining element p2, the piezoelectric vibrator 20 expands, whereby the pressure chamber 28 rapidly contracts from the maximum volume to the minimum volume corresponding to the minimum potential Vmin. Ink in the pressure chamber 28 is pressurized due to rapid contraction of the pressure chamber 28, and in this way, several p1 to several tens of p1 of ink is ejected from the nozzle 30. A contraction state of the pressure chamber 28 is maintained for a short time over an application period of the contraction maintaining element p4, and thereafter, the vibration suppression element p5 is applied to the piezoelectric vibrator 20, so that the pressure chamber 28 returns from a volume corresponding to the minimum potential Vmin to the reference volume corresponding to the reference potential Vb.

Then, a feature of the printer 1 according to an embodiment of the invention is that voltage is applied to the platen 5 by the platen applied voltage generation section 58, so that the platen 5 is set to have a voltage selected from among voltages equal to or higher than −305 V and lower than 0 V. In addition, with respect to the voltage which is applied to the platen 5, any voltage is also acceptable, provided that it is equal to or higher than −305 V and lower than 0 V, and any waveform in which voltage changes between −305 V and 0 V can also be set. Further, as described above, the nozzle plate 24 (the nozzle formation face) is electrically grounded.

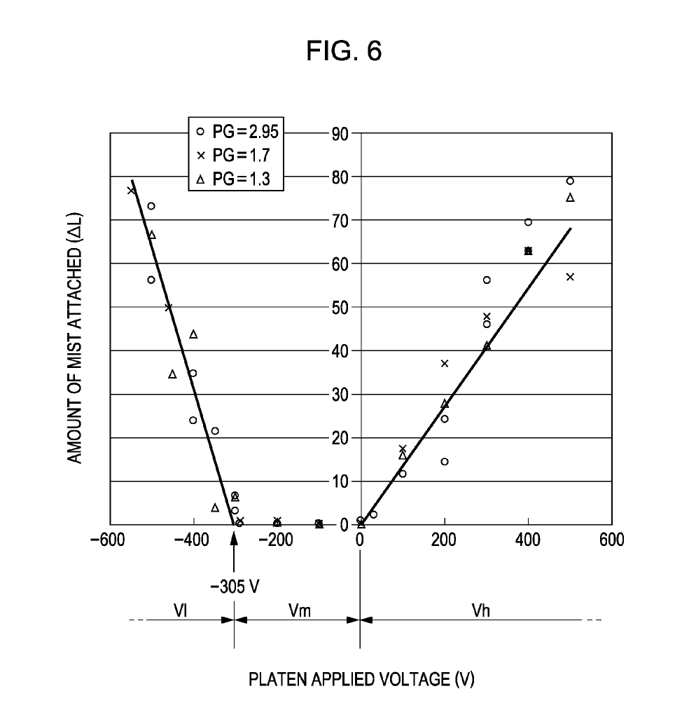

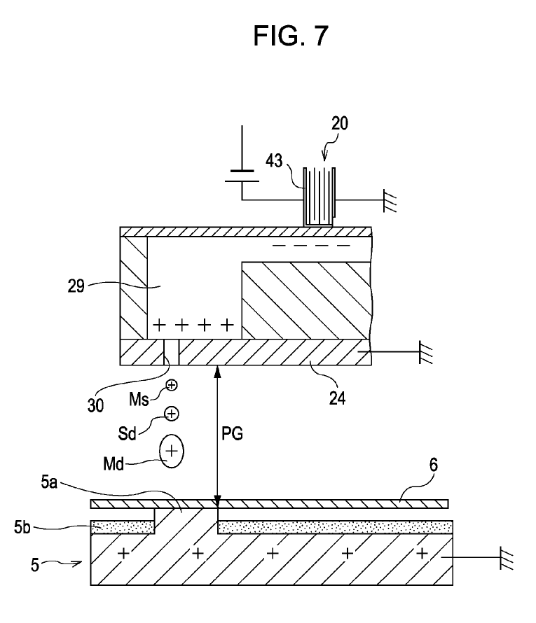

A basis for setting the voltage which is applied to the platen 5 to be equal to or higher than −305 V and lower than 0 V will be described based on a graph shown in FIG. 6. The horizontal axis shown in the graph denotes the value of a constant voltage which is applied to the platen 5 and the vertical axis denotes the amount of mist (ink) attached to the nozzle formation face, quantified as a difference in concentration (or a difference in brightness) ΔL. Further, ◯ in the graph denotes a value when the distance (a platen gap PG; refer to FIG. 7) between the support projection 5a of the platen 5 and the nozzle formation face is set to be 2.95 mm, × denotes a value when the platen gap PG is set to be 1.7 mm, and A denotes a value when the platen gap PG is set to be 1.3 mm. In addition, these values of the platen gap are selected as values in a practical range which is set in this type of printer. Further, a straight line in the graph is a line approximated to a straight line by arranging measured values in the respective platen gaps PG in each region of a voltage region V1 in which the voltage which is applied to the platen 5 is lower than −305 V, a voltage region Vm in which the voltage is equal to or higher than −305 V and lower than 0 V, and a voltage region Vh in which the voltage is higher than 0 V. In addition, the difference in concentration ΔL of the amount of mist attached can be measured, for example, in the following procedure. First, a scrap of paper is stuck to a position which does not interfere with the recording head 2, in the face on the recording head 2 side of the carriage 4. In this state, initial concentration Lb of the scrap of paper is measured by using a chroma-meter. Next, solid printing is performed on, for example, 50 sheets of recording paper 6 in a state where voltage is applied to the platen 5. Thereafter, concentration La of the scrap of paper is measured again using a chroma-meter. Then, by calculating a difference between the initial concentration Lb of the scrap of paper and the concentration La after printing, it is possible to obtain the difference in concentration ΔL of the amount of mist attached (ΔL=|La−Lb|). This procedure is repeatedly performed while changing the voltage which is applied to the platen 5 within a given range (in this embodiment, within a range from −500 V to 500 V), so that the difference in concentration ΔL of the amount of mist attached with respect to the platen applied voltage can be obtained. Further, the graph shown in FIG. 6 can be obtained by performing the same measurement with respect to each of cases where the platen gap PG is 2.95 mm, 1.7 mm, and 1.3 mm.

According to this graph, it is found that a difference in the measured values in each platen gap PG is only in the range of error and the correlation between the platen gap PG and the difference in concentration ΔL of the amount of mist attached is small. That is, it is found that if it is a platen gap in a practical range, there is almost no correlation between the difference in concentration ΔL of the amount of mist attached and an electric field intensity between the platen 5 (the support projection 5a) and the nozzle formation face. Further, it is found that the difference in concentration ΔL of the amount of mist attached generally depends only on the platen applied voltage. A mist attachment model in each region of the voltage region V1 in which the voltage which is applied to the platen 5 is lower than −305 V, the voltage region Vm in which the voltage is equal to or higher than −305 V and lower than 0 V, and the voltage region Vh in which the voltage is higher than 0 V will be described below.

First of all, electrical charging of ink ejected from the nozzle 30 will be described. As shown in FIG. 7, a liquid droplet ejected from the nozzle 30 elongates during flight, thereby being divided, for example, into a leading main droplet Md (a main droplet), a minute following satellite droplet Sd, and a mist Ms which is even more minute than the satellite droplet Sd. In general, in these droplets, while they fly toward the recording paper 6, positive charging tends to increase due to the Lenard effect (in a case where ink is ejected in a negatively charged state, negative charge tends to decrease). That is, in the ejected droplet, positive charges are collected at the central portion thereof, while negative charges are collected at the surface layer portion thereof. Then, it is known that the droplet is gradually biased to have a positive charge by evaporation or disintegration of the surface layer portion during flight. Further, in this embodiment, a positive voltage (the ejection driving pulse DP; refer to FIG. 5) is applied to the piezoelectric vibrator 20 (the individual external electrode 43) of the recording head 2 and the nozzle formation face is grounded. For this reason, as shown in FIG. 7, negative charges are induced in ink in the vicinity of the piezoelectric vibrator 20 in the pressure chamber 28 due to electrostatic induction and also positive charges are induced in ink in the vicinity of the nozzle 30 which becomes the opposite side to the piezoelectric vibrator 20. If ink is ejected in this state, ink is ejected from the nozzle 30 in a state where a positive charge remains. For this reason, each droplet is positively charged more easily.

Next, the mist attachment model in the voltage region Vh in which the voltage which is applied to the platen 5 is higher than 0 V will be described. As shown in FIG. 7, if voltage higher than 0 V is applied, so that the platen 5 is positively charged (the recording paper 6 which comes into contact with the platen 5 is also positively charged), since each of the droplets Md, Sd, and Ms has also been positively charged, a repulsive force caused by a Coulomb force acts between these droplets and the platen 5. Further, a force (attraction) which is directed to the platen 5 side acts on each of the droplets Md, Sd, and Ms due to an inertial force at the time of ejection and the force of gravity. Then, the force acting on each of the droplets Md, Sd, and Ms is determined by the resultant force of these. Here, in the main droplet Md and the satellite droplet Sd, since the mass thereof is relatively large, the inertial force and the force of gravity are superior to the Coulomb force, so that the droplets land on the recording paper 6. In contrast, in the mist Ms, since the mass thereof is very small compared to the main droplet Md or the satellite droplet Sd, so that the inertial force and the force of gravity acting thereon are small, the mist Ms slowly heads for the recording paper 6 (in a case where the recording paper 6 has been discharged from the platen, the platen 5) while floating. Then, if the mist Ms approaches the platen 5, the Coulomb force is superior to an inertial force and the force of gravity, so that a force which is directed to the opposite side (the nozzle formation face side) to the platen 5 acts thereon. In this way, the mist Ms moves toward the nozzle formation face side and lands on the nozzle formation face (or a component of the printer 1, for example, a driving motor, a driving belt, a linear scale, or the like). If the voltage which is applied to the platen 5 is increased, a force which is directed to the nozzle formation face side due to the Coulomb force becomes large and accordingly, the mass of the mist Ms which lands on the nozzle formation face or the like also becomes large. For this reason, in the voltage region Vh higher than 0 V shown in the graph of FIG. 6, the difference in concentration ΔL of the amount of mist attached of the nozzle formation face becomes large in accordance with an increase in voltage.

On the other hand, in the case of the voltage region Vm in which the voltage which is applied to the platen 5 is equal to or higher than −305 V and lower than 0 V, since the platen 5 is negatively charged, the Coulomb force acting between each of the droplets Md, Sd, and Ms and the platen 5 becomes an attraction. For this reason, the resultant force of the Coulomb force, the inertial force, and the force of gravity becomes a force which is directed to the platen 5. In this way, each of the droplets Md, Sd, and Ms moves toward the platen 5 side (the recording paper 6 side) and lands in the recording paper 6. In addition, since the mist Ms has a small mass and easily floats, it is preferable to reduce the voltage which is applied to the platen 5 as much as possible. In this way, the Coulomb force acting on the platen 5 and the mist Ms can be increased, so that it is possible to make the mist Ms quickly land on the recording paper 6. Further, preferably, the voltage which is applied to the platen 5 is equal to or higher than −150 V and lower than −50 V.

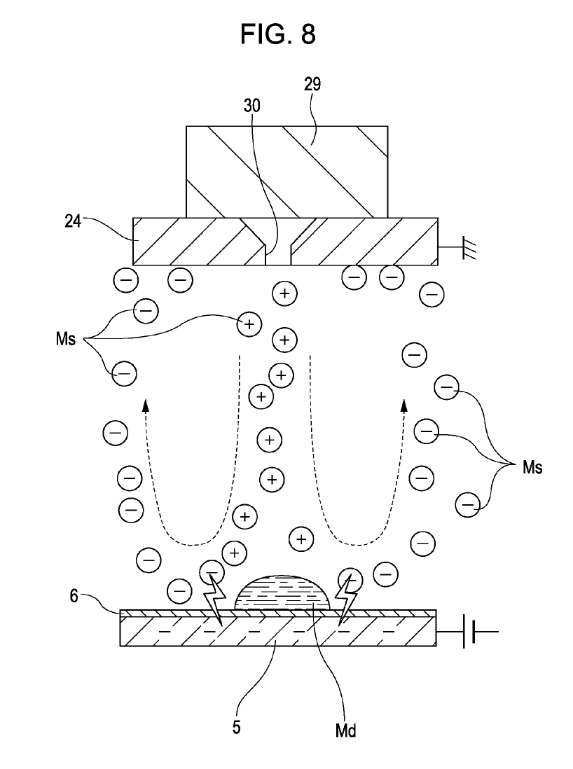

However, if the voltage which is applied to the platen 5 is set to be lower than −305 V, as shown in FIG. 8, each of the droplets Md, Sd, and Ms moves toward the platen 5 side, similarly to the above, and if the droplet approaches the platen 5 (in a case where the recording paper 6 is present on the platen 5, the recording paper 6), since the droplet is subjected to electrical discharge from the platen 5 or the like, the droplet is negatively charged. As described above, since the main droplet Md and the satellite droplet Sd have a relatively large mass, even if the droplets are negatively charged, an inertial force and the force of gravity are superior to the Coulomb force, so that the droplets land on the recording paper 6. On the other hand, since the mist Ms has a relatively small mass, the Coulomb force is superior to an inertial force and the force of gravity, so that a force which is directed to the nozzle formation face side acts thereon, whereby the mist moves toward the nozzle formation face side and all or some of the mist lands on the nozzle formation face or the like. In addition, a discharge phenomenon as described above is explained by Paschen's Law. According to Paschen's Law, it is known that electrical discharge in air at atmospheric pressure (1 atm.) starts to occur at a voltage difference of about 330 V. In this embodiment, since a liquid droplet is easily positively charged by the Lenard effect or the like, it is estimated that the above electrical discharge occurs even at −305 V, which is higher than −330 V, as the voltage which is applied to the platen 5.

In this manner, in the voltage region V1 in which the voltage which is applied to the platen 5 is lower than −305 V and the voltage region Vh in which the voltage is higher than 0 V, attachment of mist to the nozzle formation face, a component in the printer 1, or the like occurs. For this reason, in the invention, the voltage which is applied to the platen 5 is set to be in the voltage region Vm in which the voltage is equal to higher than −305 V and lower than 0 V. In this way, it is possible to suppress electrical charging of mist which is generated along with liquid droplets which are ejected from the nozzle 30, so that attachment of the mist to the nozzle formation face, a component in the printer 1, or the like can be reduced. As a result, breakdowns due to the attachment of mist are prevented, so that it is possible to improve the durability and reliability of the printer 1.

In addition, in each embodiment described above, as the pressure generation section, the piezoelectric vibrator 20 of a so-called longitudinal vibration type has been illustrated. However, it is not limited thereto and it is also possible to adopt, for example, a piezoelectric vibrator of a so-called flexural vibration type. In this case, the waveform of the driving signal (the ejection driving pulse DP) illustrated in FIG. 5 becomes a waveform in which the direction of a change in potential, that is, up-and-down, is reversed. In addition, it is also possible to apply the invention to the configuration of adopting, as the pressure generation section, a pressure generation section which is driven by application of voltage, such as a heat generation element which causes a fluctuation in pressure by suddenly boiling ink by heat generation or an electrostatic actuator which causes a fluctuation in pressure by displacing a partition wall of a pressure chamber by an electrostatic force.

Further, provided that it is a liquid ejecting apparatus in which liquid ejection control can be performed with use of a pressure generation section, the invention is not limited to a printer and can also be applied to various ink jet type recording apparatuses such as a plotter, a facsimile machine, and a copying machine, liquid ejecting apparatuses other than a recording apparatus, for example, a display manufacturing apparatus, an electrode manufacturing apparatus, a chip manufacturing apparatus, and the like. Then, in the display manufacturing apparatus, a solution of each color material of R (red), G (green), B (blue) is ejected from a color material ejecting head. Further, in the electrode manufacturing apparatus, a liquid electrode material is ejected from an electrode material ejecting head. In the chip manufacturing apparatus, a solution of biological organic matter is ejected from a biological organic matter ejecting head.

The entire disclosure of Japanese Patent Application No. 2011-083392, filed Apr. 5, 2011 is expressly incorporated by reference herein.

What is claimed is:

1. A liquid ejecting apparatus comprising:
a liquid ejecting head which ejects liquid toward a landing target from a nozzle opened in an electrically grounded nozzle formation face;
a support section which is disposed spaced apart from the nozzle formation face of the liquid ejecting head when performing an ejection operation and supports the landing target; and
a voltage application section which applies voltage to the support section,
wherein the voltage which is applied to the support section is set to be equal to or higher than −305 V and lower than 0 V.

2. A method of controlling a liquid ejecting apparatus which includes
a liquid ejecting head which ejects liquid toward a landing target from a nozzle opened in an electrically grounded nozzle formation face;
a support section which is disposed spaced apart from the nozzle formation face of the liquid ejecting head when performing an ejection operation and supports the landing target; and
a voltage application section which applies voltage to the support section,
the method comprising:
setting the voltage which is applied to the support section to be equal to or higher than −305 V and lower than 0 V.
